(19) United States
(12) Patent Application Publication
(10) Pub. No.: US 2005/0086541 A1
(43) Pub. Date: Apr. 21, 2005

(54) Service access

(76) Inventor: Jaakko Rajaniemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/500,370

(22) PCT Filed: Dec. 20, 2002
(86) PCT No.: PCT/IB02/05597

(30) Foreign Application Priority Data
Dec. 28, 2001 (GB) 0131046.5

(51) Int. Cl. H04L 9/32

(52) U.S. Cl. 713/202

(57) ABSTRACT

A method for providing access to a service for a user in a communication system, comprising the steps of: using a specific record associated with said user, at a node in the communication system, containing information which, determines that a user is to be verified prior to providing access to said service.

The present invention relates to a method and apparatus for providing access to a service. In particular, but not exclusively, the present invention provides a user of mobile user equipment in a wireless communication system with access to internet multimedia services.

The introduction of Third Generation (3G) communication systems will significantly increase the possibilities for accessing services on the internet via mobile user equipment (UE).

Various user equipment (UE) such as computers (fixed or portable), mobile telephones, personal data assistants or organisers and so on are known to the skilled person and can be used to access the internet to obtain services. Mobile user equipment referred to as a mobile station (MS) can be defined as a means that is capable of communication via a wireless interface with another device such as a base station of a mobile telecommunication network or any other station. Such a mobile user equipment can be adapted for voice, text message or data communication via the wireless interface.

The term “service” used above and hereinafter will be understood to broadly cover any service or goods which a user may desire, require or be provided with. The term also will be understood to cover the provision of complimentary services. In particular, but not exclusively, the term “service” will be understood to include internet multimedia services (IMS), conferencing, telephony, gaming, , rich call, presence, e-commerce and instant messaging.

The 3G Partnership Project (3GPP) is defining a reference architecture for the Universal Mobile Telecommunication System (UMTS) core network which will provide the users of UE with access to these services. This UMTS core network is divided into three principal domains. These are the Circuit Switched domain, the Packet Switched domain and the Internet Protocol Multimedia (IM) domain.

The latter of these, the IM domain, makes sure that multimedia services are adequately managed. The IM domain supports the Session Initiation Protocol (SIP) as developed by the Internet Engineering Task Force (IETF).

SIP is an application layer signalling protocol for starting, changing and ending user sessions. A session may, for example, be a two-way telephone call or multi-way conference session. The establishment of these sessions enables a user to be provided with the services above mentioned. One of the basic features of SIP is that the protocol enables personal mobility of a user using mobile UE by providing the capability to reach a called party via a single location independent address.

In view of this high level of mobility it is important to provide a way for users to indicate to a service provider that they are entitled to be provided with a service. In this sense internet service providers (ISP's) and mobile operators require user authentication, authorisation and accounting (AAA) when granting access to network resources. Certain well-established authentication mechanisms, such as DIAMETER, have been developed and are usable with SIP for verifying that a user is permitted to access the service.

The communication system will include many component parts including a local serving network, where the UE is located, a home network and an SIP network which is an overlay to the packet switched (PS) domain. The IM domain in 3GPP includes a number of different entities including a proxy call state control function (P-CSCF) which is the UE point of contact in the serving (visiting) network. It is this point where the network places constraints on the bearer supporting the session. P-CSCF corresponds to a SIP proxy in the general SIP framework. The IM domain also includes a serving call state control function (S-CSCF) which is located in the home network of the user and which is responsible for identifying the user's service privileges. S-CSCF corresponds to a SIP registrar in the general SIP framework. The S-CSCF selects and provides access to the home network provides authentication, authorisation and accounting home server (AAA-H) which provides authentication, authorisation and accounting checking. In addition the IM domain includes at least one interrogating call state control function (I-CSCF) which locates the S-CSCF upon a request for registration by the UE. I-CSCF may use AAA-H server for locating the S-CSCF. I-CSCF corresponds to a SIP proxy in the general SIP framework.

When a user registers to the SIP network verification of a user's authenticity and/or authorisation to receive services is carried out after which point in time access to services may be permitted.

However, SIP does not require the user to register to the network before it can request service. Therefore, it is possible that the network performs authentication and/or authorization in the beginning of the SIP session initialization.

In order to help maintain an acceptably high level of security in the communication system it is advantageous to ensure that the authenticity and/or authorisation of a user is verified at predetermined intervals or on the occurrence of predetermined events. For example whenever an SIP session is initiated. Earlier, in order to do a check, the information required to carry out this check has been stored in the Home network of the user in the AAA-H. Therefore a roundtrip of messaging signals to the AAA-H has been required which can be time consuming and has lead to undue delay in the provision of services. Additionally if a check is made for every SIP session a large load is placed on the communication system to enable sufficient communication links and/or bandwidth to be allocated to enable this to be carried out. Especially, this is problematic in wireless networks where the bandwidth may be very limited in the air interface.

It is an aim of embodiments of the present invention to at least partly mitigate the above-referenced problems.

According to a first aspect of the present invention there is provided a method for providing access to a service for a user in a communication system, comprising the steps of: storing a specific record, associated with said user, at a node in the communication system, containing information which, that a user is to be verified prior to providing access to said service.

According to a second aspect of the present invention there is provided a method for providing a user of user equipment with access to a service from a service provider node in a wireless communication system, comprising the steps of, using a user specific record indicating a condition which, if satisfied, determines that a user characteristic is to be verified prior to providing access to said service; and providing access to said service responsive to said user specific record.

According to a third aspect of the present invention there is provided a server node of a communication system for providing a user or user equipment with access to a service from a service provider node, said server node comprising: means for receiving a message from said user equipment; means for using a user specific record, associated with said user, indicating a condition which, if satisfied, determines that a user characteristic is to be verified prior to providing said user with access to said a service.

According to a fourth aspect of the present invention there is provided mobile user equipment, for providing a user with access to a service from a service provider node, comprising: means for using a user specific record associated with said user, indicating a condition which, if satisfied, determines that a user characteristic is to be verified prior to providing said user with access to said a service; and means for generating, in response to said user specific record, an access message for providing said user with access to said service.

Embodiments of the present invention provide the advantage that the user's validity to be provided with a service is verified at least at a predetermined frequency to ensure that a user is duly authorised and/or authentic. This is done in a manner which reduces the load/volume of traffic on the communication system and also reduces the delay in providing such verification compared to prior art systems.

For a better understanding of the present invention reference will now be made, by way of example only, to the accompanying drawings in which:

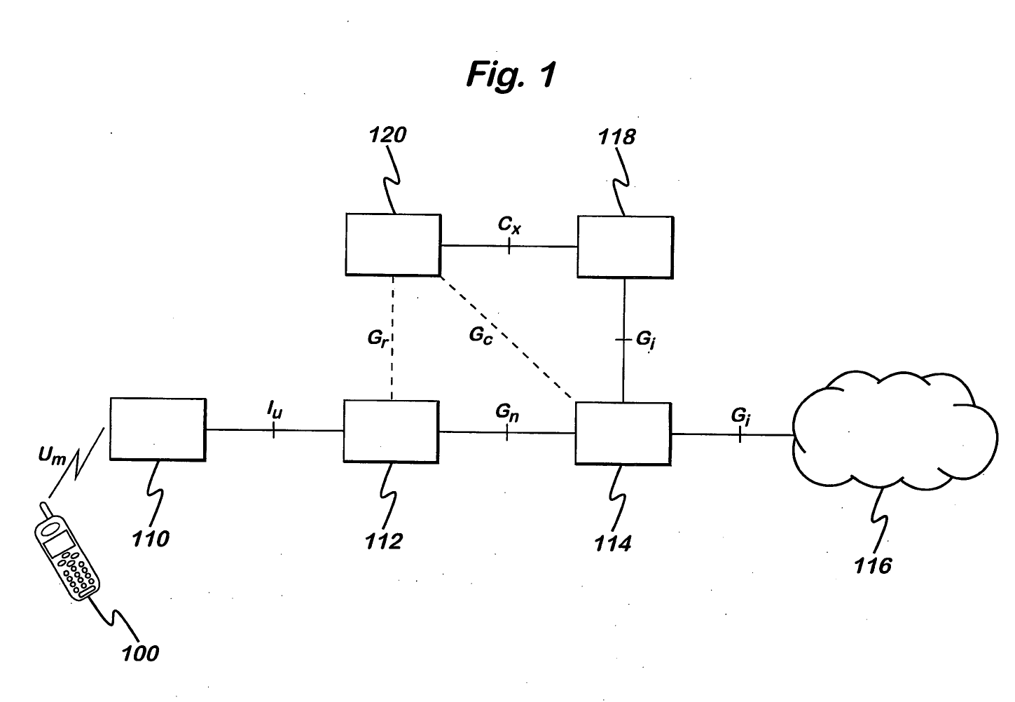

FIG. 1 illustrates a partial IP multimedia architecture;

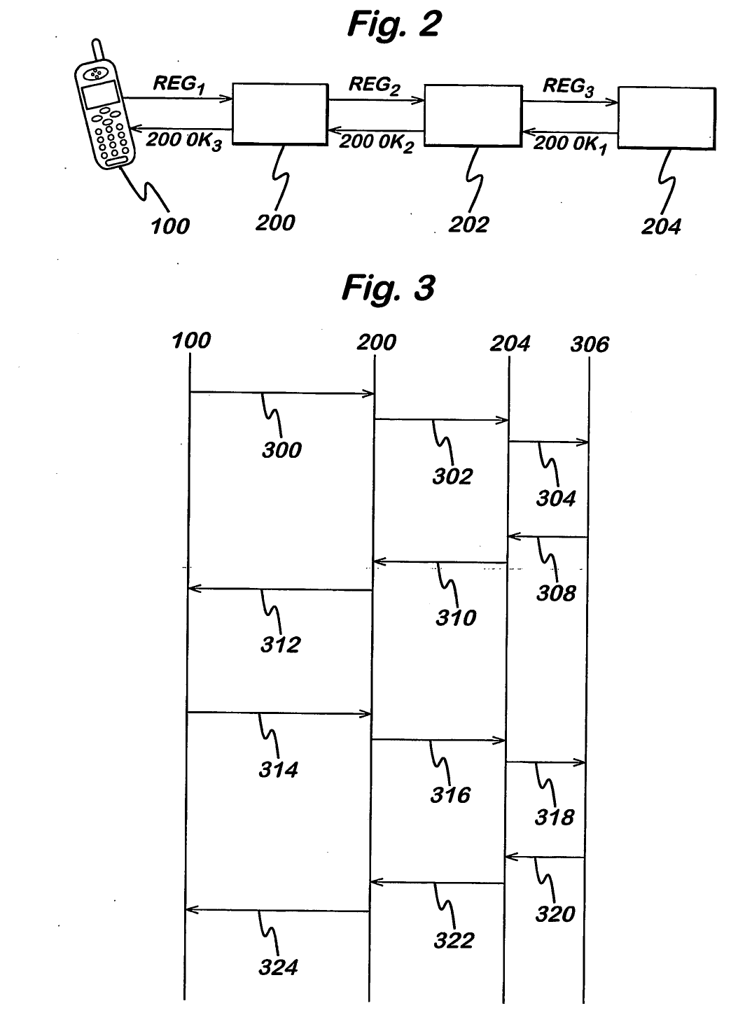

FIG. 2 illustrates conventional access authentication;

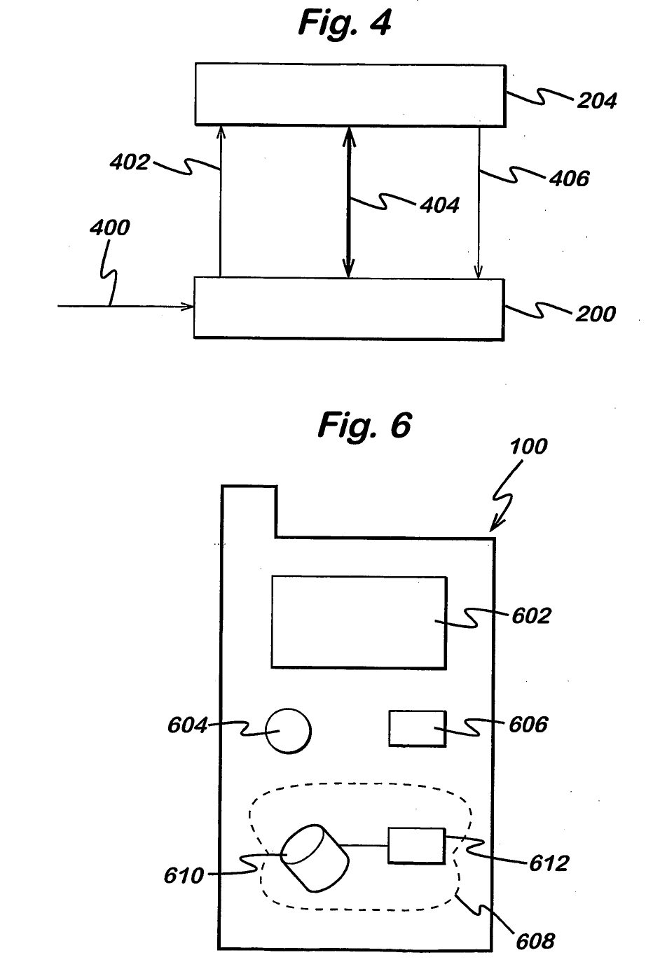

FIG. 3 illustrates a procedure for verification of a user;

FIG. 4 illustrates the transfer of a user specific record;

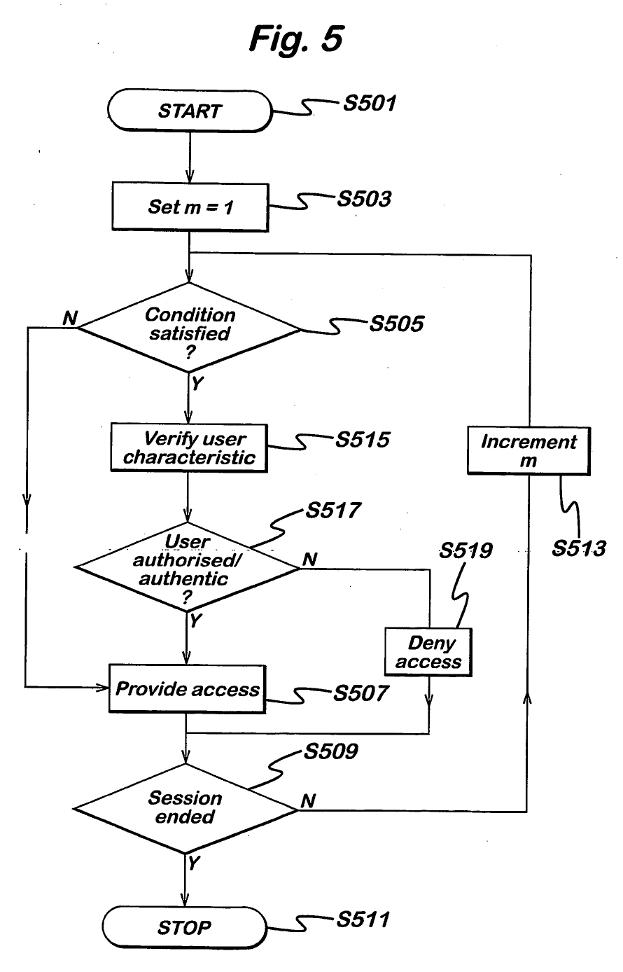

FIG. 5 illustrates a process for providing access to a service;

FIG. 6 illustrates a mobile station.

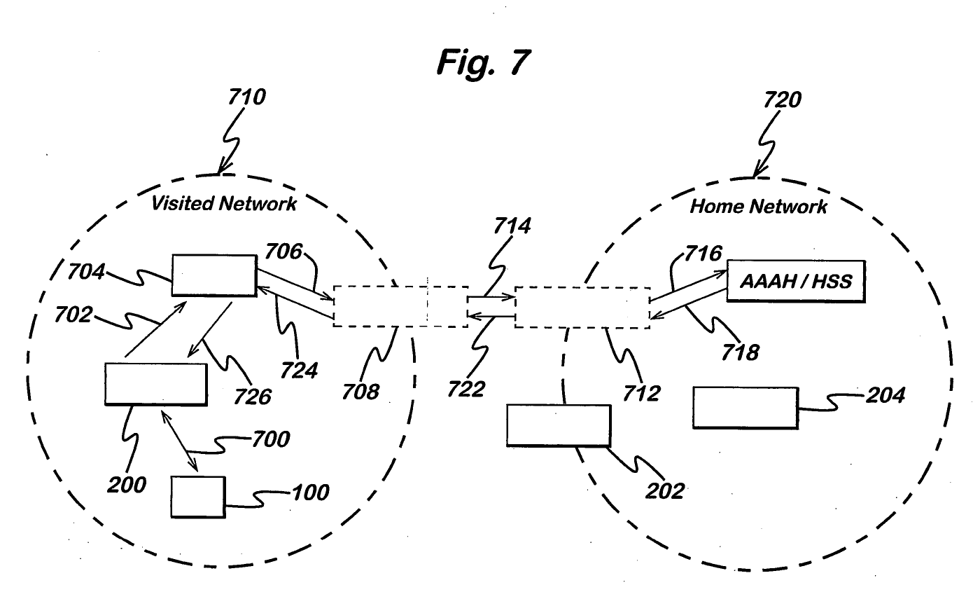

FIG. 7 illustrates an alternative Registration process; and

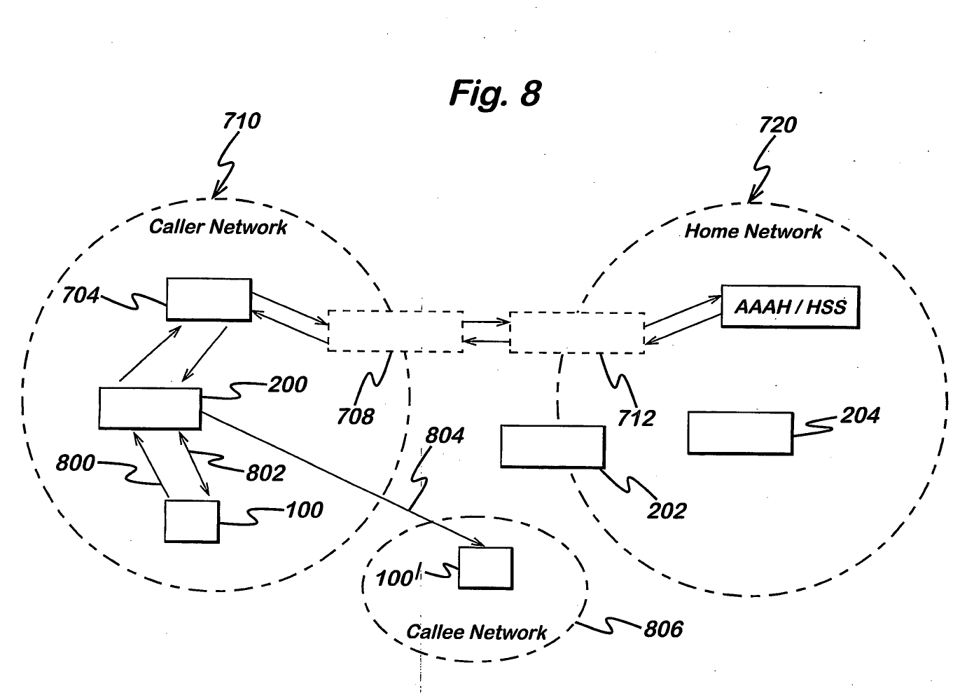

FIG. 8 illustrates an INVITE process with authorisation and/or authentication.

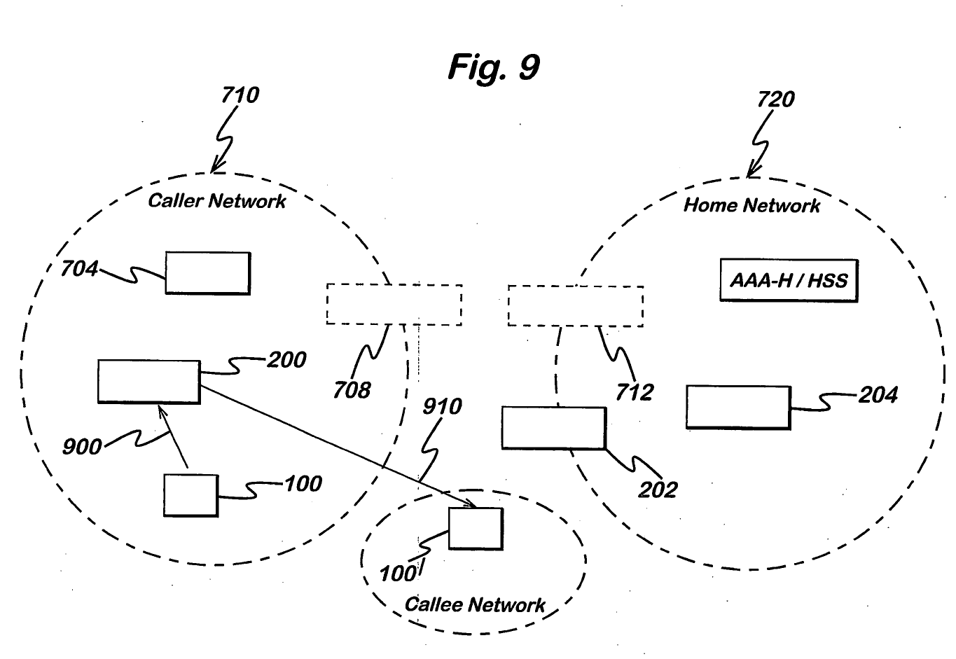

FIG. 9 illustrates an INVITE process without authorisation and/or authentication from the AAA-H. In the drawings like reference numerals refer to like parts.

FIG. 1 illustrates a partial internet protocol (IP) multimedia network architecture. A mobile station (MS) 100 can be a mobile telephone or a laptop computer which has a radio modem or a fax adapted for radio access. The term MS is used here as an example of mobile user equipment (UE). This communicates with the Universal Mobile Telecommunication System (UMTS) Radio Access Network (UTRAN) 110 over the radio interface (Uₘ). The UTRAN includes a network element node B, which provides equipment for transmission and reception of messages and may additionally include ciphering equipment. This communicates with a radio network controller (RNC) 110 as is known in the art.

The RNC 110 sets up the radio channels for signalling to the core network node 112 which may comprise a serving General Packet Radio Service GPRS support node (SGSN). The signalling occurs over the Iᵤ interface. The SGSN provides the network access node and mobility management functions. The node 112 is essentially a switching node which can perform connection management, mobility management and authentication activities. The core network node 112 is connected to the gateway GPRS support node (GGSN) 114 via the Gₙ interface. The GGSN provides access, via the Gᵢ interface, to the services area 116 over IP packet data networks such as the internet and internet service providers (ISP).

The call state control function (CSCF) 118 supports and controls sessions during which the UE obtains IMS services from the services area 116. In addition, CSCF may consist of Proxy, Interrogating and Serving CSCFs as described earlier. The CSCF provides flexibility to modify, add or erase bearers used by the users services as will be discussed in more detail hereinafter. Amongst other functions the CSCF 118 controls call functions, thus executes call setup, modification and termination and performs address handling. The CSCF accesses the Home Subscriber Server (HSS) 120 via the CX interface. The HSS is a master server containing data relating to a particular user. It contains data relating to a specific user which can identify how call services are to be carried out and authentication and authorization information. The HSS is located in the home network of the UE user which may be some distance from the location of the UE, which is serviced by a local (visited) network. The HSS is connected to the SGSN 114 and GGSN via the Gᵣ and G_{c} interfaces respectively.

In order to provide access to internet and other IM services to users, protocols have been developed to assist in providing telephony services across the internet. The session initiation protocol (SIP) is one such protocol which has been developed for controlling the creation, modification and termination of sessions with one or more parties. The call sessions may include internet or other IP network telephone calls, conferences or other multimedia activities.

SIP addressing follows the popular internet convention of identifying a user by a unique address using Uniform Resource Locators (URL's). SIP signalling between two users consists of a series of requests and responses. A SIP transaction has dual parties, the user agent client (UAC) who sends a request and a user agent server (UAS) who responds in reply to the request. The client and server comprise the SIP user agent. In addition to this SIP includes the SIP network server which is the network device/s which handle signalling associated with multiple calls.

As is known in the art an SIP invitation typically includes two messages. It will be understood that there may be more messages than only these and that, in fact, in 3GPP there are more messages used. These are not discussed herein for the sake of brevity. The two messages are an INVITE, initiated by the caller UAC and a 200 OK message from the callee. This latter message is typically acknowledged by the caller after which stage the parties may communicate according to parameters sent and received during signalling. Both caller and callee can end a session by executing a BYE message. During an established session a new set of parameters may be selected by either participant producing a further INVITE message or by using some other SIP message.

SIP also provides for registration which enables a user to be reached/contacted. SIP clients register themselves with the communication system using a REGISTER message which requests are directed to SIP servers termed Registrars in the SIP network.

The SIP Network includes proxies and other server nodes which may be included in other elements of the communication system or may comprise separate elements. FIG. 2 illustrates the registration system.

The UE 100 which may comprise the UAC issues a register message REG, to a proxy-call state control function (P-CSCF) node 200. This is the UE point of contact in the serving network of the communication system where the UE is located. The P-CSCF 200 directs the call to the home network of the user of the UE 100. The P-CSCF node 200 issues a register message REG₂ to the interrogating CSCF (I-CSCF) 202. This network element is located in the home network of the communication system and directs the registration request to the serving CSCF (S-CSCF) 204 with a registration request REG₃. I-CSCF may interrogate the HSS for locating the S-CSCF. The S-CSCF acts as a Registrar network element and identifies the service privileges of the user requesting registration. Once these have been identified the registration is completed with a flow of 200 OK messages from the S-CSCF 204 to the I-CSCF 202, to the PCSCF 200 and to the UE 100.

It will be understood that it is important for the recipient of an SIP message to be able to confirm that the caller is who he is holding himself out to be. Also in the case of internet service providers (ISP) it is important that the ISP's can verify that the caller is duly authorised to access the required services and/or that he can pay for those services. In this sense ISP's are said to require AAA, user authorisation, authentication and accounting when granting access to their network resources.

Accounting is the act of collecting information on resource usage for the purpose of trend analysis, auditing, billing, or cost allocation. Authentication is the act of verifying a claimed identity, in the form of a pre-existing label from a mutually known name space, as the originator of a message (message authentication) or as the end-point of a channel (entity authentication). Authorisation is the act of determining if a particular right, such as access to some resource; can be granted to the presenter of a particular credential.

FIG. 3 illustrates how AAA can be achieved using an authentication mechanism requiring accessing data stored in the AAA-H. The UE 100 issues a register message 300 to the local proxy 200. A local proxy is a proxy that may exist within the same administrative domain as the network device that issued the register via the REGISTER message. Typically a local proxy is used to multiplex AAA messages to and from a large number of network devices, and may implement policy. The local proxy 200 issues a register message 302 to the Registrar node, (which may be directed via an I-CSCF as noted above). In response to the register message 302 the Registrar 204 enquires, with message 304, from a server 306, which is associated with the home AAA server, about the caller's status. In the case of an as yet unauthorised caller the server 306 responds with an unauthorised message 308 which acts as a server created challenge. The server 204 signals an unauthorised message 310 to the proxy 200. The proxy returns a proxy authentication required message 312 to the UE which indicates a failure response. The header of this message describes an authentication scheme and server challenge. In reply the UE 100 creates a new request with a header field describing its authentication details. These are sent to the Registrar 204 via the proxy server 200 as messages 314 and 316. These may be used to update the server via message 318 which returns a response to the registrar server 204 and then 200 OK messages 322 and 324 to the proxy server and UE respectively created by the nodes 204 and 200. The server 306 may provide the required authentication and/authorization information already in the message 308 in which case the messages 318 and 320 may not be needed.

It will be appreciated that every time a user or the user equipment 100 requires a service, an authorisation and/or authentication request, for verifying the user accessing data stored in the AAA-H server of the home network, is required. This leads to a delay in providing the verification and to the requirement for a multitude of messaging signals to be generated and transmitted in the communication system. FIG. 4 illustrates how a user characteristic, such as authorisation and/or authenticity, can be verified at a rate which provides an acceptable level of security whilst reducing the delay prior to obtaining the verification and reducing the number of messaging signals required. When mobile user equipment 100 seeks to register or initiates a service with the communication system this request message 400 is transmitted to the P-CSCF server 200. Message 402 is transmitted from the P-CSCF to the S-CSCF 204 (this may, for example, be via an I-CSCF although this is not shown in FIG. 4 for the sake of brevity). The AAA-H which is situated in home network to which the S-CSCF has access, thereafter carries out the authentication/authorisation process illustrated in FIG. 3. This is indicated by the exchange of messages 404. In addition an authorisation and authentication profile is transmitted with message 406 from the AAA-H to the S-CSCF 204 or to the P-CSCF 200. It will be understood that in accordance with embodiments described hereinafter the profile could be sent directly to the P-CSCF from the AAA infrastructure without transferring via the Registrar (S-CSCF). This is shown in the FIGS. 7 and 8. In such examples the home network nodes I-CSCF and S-SCSF do not need to be contacted during Registration or session initiation. Once the profile is downloaded to the P-CSCF or S-CSCF the AAA-H does not need to be contacted in every registration or session initiation. The authorisation and authentication profile includes data associated with the user of the user equipment registering or initiating session. The information contained in the profile is specific to that user and includes a record detailing when the SIP network must contact the AAA-H server prior to permitting that user to access services from a service provider node and in addition to the profile, home network may also provide information to the serving element which allows the serving element, e.g. S-CSCF, to authorise and/or authenticate the user directly without contacting the home network, i.e. AAA-H. The user specific record (or profile) can indicate any predetermined rate or frequency or event at which reference must be made to the AAA-H. This rate can vary from anything between never having to authenticate and/or authorise the user prior to providing the service, to the other extreme of having to authenticate and/or authorise the user to access a service for every session between the user equipment and a service provider node. Some other alternatives are that every Nth session must be authenticated and/or authorised, only certain types of sessions, e.g. multimedia, need to be authenticated and/or authorised, authentication and/or authorisation is needed only at a certain time of day, authentication and/or authorisation is needed for sessions if more than N seconds have passed from the previous authentication and/or authorisation. In embodiments of the present invention authentication and/or authorisation is needed when a certain number of sessions are ongoing simultaneously. Alternatively authentication and/or authorisation is needed if the user is served by certain predetermined networks. Alternatively authentication and/or authorisation is needed if the user is roaming outside the home network. In this sense the user specific record indicates a condition which if satisfied determines that a user characteristic, such as for example the authenticity or authorisation of the user, must be verified before access to the service requested by a user may be provided. Once this user specific record has been transmitted from the AAA-H to the S-CSCF (or directly to P-CSCF.) reference to the record may be made every time a user registers or re-registers to the network or when every session initialisation is carried out or periodically based on some timer criteria. Thereafter if the condition, indicating that authentication and/or authorisation is required is not satisfied then access to the service may be automatically provided by the service provider without the requirement for reference to be made to the AAA-H. By setting the frequency/rate at which reference to the AAA-H should be made an acceptable level of security can be attained whilst improving the efficiency of the system. The efficiency can be improved by reducing the amount of signalling traffic required in the communication system to access the AAA-H. Alternatively embodiments of the present invention reduce the delay in providing the user with access to the services since the required signalling is reduced. In case the home network nodes, e.g. S-CSCF and AAA-H, does not necessarily be in the signalling path, the time delays in transmitting and receiving the required messaging signals may be even obviated.

It will be understood by those skilled in the art that the present invention is not limited to the condition indicated by the user specific record as noted hereinabove. Rather any rate or event could be selected for determining when the user authorisation and/or authentication should be verified before access to a required service is provided.

FIG. 5 illustrates how the method according to an embodiment of the present invention may operate. At step S501 the procedure is initiated. This may occur when the user initially registers to the network or as an alternative when session initialisation is begun. The skilled man will understand that the procedure may be begun at any other appropriate time. At step S503 the session number M is set to one to indicate that this is the first call session. It will be understood that the inclusion of the steps referring to the setting and counting of the session number M are not essential to the present invention. At step S505 a check is made to see whether a condition is satisfied. By way of example in this embodiment the condition which must be satisfied is that authorisation and authentication is verified every Mth session. Since this is the first session the condition is not satisfied since M indicating the session number is one. Thereafter a message may be generated by the P-CSCF which can be used to instruct the ISP to provide the user with access to the required service. This is step S507. After step S507 a check is carried out to determine whether the call session has ended. This could be for example when the user wished to end a call session with the issuance of a BYE message this is step S509. If the session is ended the procedure stops at step S511. If the session is not ended then the session number M is incremented by one at step S513 and the process is repeated. Once the session number M has been incremented to N the check at step S505 whether the condition is satisfied will be positive. When the condition is met a user characteristic such as the authentication or authorisation of the user to be provided access to the services is checked at step S515 and the question of whether the authorised and/or authenticated to access the service is determined at step S517. Access is provided at step S507 if the verification procedure indicates that the user may be provided with the service whilst at step S5019 a failure of the user to be authorised and or authenticated results in the denial of access to the service provided by the SIP.

FIG. 7 illustrates how, according to further embodiments of the present invention, the Registration process of a mobile station 100 may take place without reference messages being required to the I-CSCF 202 or the S-CSCF 204. The mobile station 100 sends and receives messages from the P-CSCF 200 over link 700 which will be initiated by a REGISTER message. Upon receipt of the REGISTER message the P-CSCF 200 issues an AAA request message 702 to an AAA function node (AAA-F) 704 in the visited network 710. The node 704 includes functionality for receiving and transmitting messaging signals from the P-CSCF to further AAA infrastructure in the system. AAA-F node may have some functionality for performing local decisions such as whether it authorizes the access to the user. The AAA-F node 704 transmits an AAA request message 706 to an AAA proxy 708 which contacts an AAA proxy 712 in the home network 720 of the user 100. This is illustrated by message 714. The AAA proxy 712 transmits an AAA request message 716 to the AAA-H server. An AAA answer 718 which includes the AAA profile of the user of the MS 100 is returned from the AAA-H via the AAA proxy servers 708 and 712 and via message 722. The AAA proxy 708 returns the AAA profile via message 724 to the AAA function node 704 which directs the profile via message 726 to the P-CSCF. The P-CSCF 200 can store the authorisation profile so that subsequent requests do not require access to the AAA-H as above described. It is noted that the AAA infrastructure used in the example FIG. 7 may have different configurations in different networks.

FIG. 8 illustrates how an INVITE process can be carried out in accordance with embodiments of the present invention. The INVITE message 800 is transmitted from the MS 100 to the P-CSCF 200. Thereafter a user profile can be transferred from the AAA-H back to the P-CSCF as described in relation to FIG. 7. Once the P-CSCF has received the user profile authentication and/or authorisation messages can be transmitted to the MS 100 via message 802. The MS responses the authentication and/or authorisation message with the response to a possible challenge. After the MS has been authenticated and/or authorised, which may require another roundtrip to the home AAA-H server, the P-CSCF 200 transmits an INVITE message 804 to mobile station 110′ which represents the callee in the callee network 806. It will be understood that once the AAA user profile has been transferred to the P-CSCF 200 subsequent requests from the MS 100 to invite callee 100′ can be made without reference to the AAA-H being made via the AAA infrastructure (704, 708, 712).

FIG. 9 illustrates an INVITE process without the requirement of authorisation and/or authentication from the AAA-H. This occurs subsequent to the process by which the user profile has been transferred to the P-CSCF 200. In this situation an INVITE message 900 is issued from the MS 100 in the P-CSCF and subsequent to this verification an INVITE message 910 is transmitted to the callee 100′. This occurs without the need for authorisation from any other network node.

It will be understood that in accordance with other embodiments of the present invention the verification of a user characteristic will be carried out upon the occurrence of other pre-determined events. Under these conditions the method depicted in FIG. 5 would be modified accordingly.

In accordance with embodiments of the present invention the user specific record may be stored in a data store of the S-CSCF.

In accordance with embodiments of the present invention the user specific record may be stored in a data store of the P-CSCF. According to other embodiments the user specific record may be stored in the home network of the communication system. It will be appreciated in this latter case that the time delay effects above-referenced will not be as greatly improved, however the provision of the user specific record which indicates times or events when no authentication and/or authorisation need to be carried out will nevertheless result in a reduction in delay of providing a user with access to this service and to a reduction in the total number of messaging signals requiring generation, transmittal and receipt in the system. FIG. 6 illustrates a mobile station 100 in which the user specific records may be stored in accordance with further embodiments of the present invention. The mobile station includes a display 605 and buttons 604,606 which together with a microphone and ear piece (not shown) provide a portion of a user interface. The mobile station is illustrated cut away (as shown by phantom line 608) to reveal a data storage unit 610 controlled via processor and control means 612. The provision of the user specific record in the mobile station 100 results in an appreciable reduction in the delays caused by having to verify the user characteristics prior to providing a user with the service. It will be understood that the present invention is in no way limited to MS configured in this manner.

It will be appreciated by those skilled in the art that embodiments of the present could be applied to the provision of any SIP transaction, for example the re-registration or SIP based presence and instant messaging services.

It will also be appreciated that embodiments of the present invention are applicable to SIP and AAA infrastructure interoperation for example over the 3GPPIMS Cx interface.

Embodiments of the present invention provide a means by which the signalling load between the home AAA ,SIP entities and the terminal can be decreased. In addition the signalling delay can be reduced for sessions which do not require authentication and/or authorisation since the SIP entity, for example the SIP proxy, may be located in the visited network far from the home network where the Home AAA is located.

1. A method for providing access to a service for a user in a communication system, comprising the steps of:
using a specific record, associated with said user, at a node in the communication system, containing information which, determines that a user is to be verified prior to providing access to said service.

2. The method as claimed in claim 1 further comprising the steps of:
transferring said information from the AAA-H to the serving node in the signalling path for the service setup and/or service event and/or registration.

3. The method as claimed in claim 1 further comprising the steps of:
deciding based on said information that the authentication and/or authorization needs be verified.

4. The method as claimed in claim 1 further comprising the steps of:
performing the authentication and/or authorization.

5. The method as claimed in claim 4 further comprising the steps of:
performing the authentication and/or authorization by using the AAA-H.

6. The method as claimed in claim 4 further comprising the steps of:
performing the authentication and/or authorization in the node if the required parameters are available.

7. A method for providing a user of user equipment with access to a service from a service provider node in a wireless communication system, comprising the steps of:
using a user specific record indicating a condition which, if satisfied, determines that a user characteristic is to be verified prior to providing access to said service; and
providing access to said service responsive to said user specific record.

8. The method as claimed in claim 7 further comprising the steps of:
determining if said condition is satisfied; and
providing access to said service without verifying said user characteristic if said condition is not satisfied.

9. The method as claimed in claim 7 further comprising the steps of:
determining if said condition is satisfied;
verifying said user characteristic if said condition is satisfied; and
subsequent to said step of verifying the user characteristic providing access to said service if said user characteristic indicates the user is permitted access to said service.

10. The method as claimed in claim 7 further comprising the steps of:
determining if said condition is satisfied when a call session between said user and said service provider node is initiated.

11. The method as claimed in claim 7 further comprising the steps of:
determining from the user specific record associated with said user if said condition exists during a call session between said user equipment and said service provider node.

12. The method as claimed in claim 7 wherein said wireless communication system comprises a serving network in which said user equipment is located, and a home network, said method further comprising the steps of:
indicating, via said user specific record, when access to said service is permitted without determining, from data stored at a node in said home network, if access is permitted.

13. The method as claimed in claim 7 wherein said wireless communication system comprises a serving network in which said user equipment is located, and a home network, said method further comprising the step of:
storing said user specific record at a node of said serving network.

14. The method as claimed in claim 7 further comprising the steps of:
generating a register message at said user equipment and transmitting said register message to a local server node of said communication system;
determining if a condition indicated by said user specific record stored at said local server node is satisfied;
generating an access message at said local server node indicating that access to said service is permitted; and
transmitting said access message to said service provider node.

15. The method as claimed in claim 14 further comprising:
prior to said step of storing said user specific record, generating a request message at said local server node and transmitting said request message to the home AAA server of the user; and
transferring data comprising said user specific record from said home AAA server to said local server node responsive to said request message.

16. The method as claimed in claim 7 further comprising:
generating an invite message at said user equipment and transmitting said invite message to a local server node of said communication system;
determining if a condition indicated by said user specific record stored at said local server node is satisfied;
generating an access message at said local server node indicating that access to said service is permitted; and
transmitting said access message to said service provider node.

17. The method as claimed in claim 7 wherein said user characteristic comprises whether said user is authorised to access said service.

18. The method as claimed in claim 7 wherein said user characteristic comprises whether said user is authenticated to access said service.

19. The method as claimed in claim 7 wherein said condition determines the frequency at which said user is to be authorised and/or authenticated during a call session between said user equipment and said service provider node.

20. The method as claimed in claim 1 wherein said step of using a specific record comprises storing a user specific record.

21. A server node of a communication system for providing a user of user equipment with access to a service from a service provider node, said server node comprising:
means for receiving a message from said user equipment;
means for using a user specific record, associated with said user, indicating a condition which, if satisfied, determines that a user characteristic is to be verified prior to providing said user with access to said a service; and
means for generating, in response to said user specific record, an access message for providing said user with access to said service.

22. The server node as claimed in claim 21 further comprising:
means for transmitting said access message to a service provider node.

23. A server node as claimed in claim 21 further comprising:
means for receiving data comprising said user specific record transmitted from a home AAA server node.

24. A server node as claimed in claim 21 comprising a serving or proxy-call session control function node.

25. A server node as claimed in claim 21 wherein said user specific record comprises a first data field identifying said user and a second data field determining when authentication and/or authorisation of said user is required in order to access said service.

26. The server node as claimed in claim 21 wherein said means for using a user specific record comprises means for storing.

27. Mobile user equipment, for providing a user with access to a service from a service provider node, comprising:
means for using a user specific record associated with said user, indicating a condition which, if satisfied, determines that a user characteristic is to be verified prior to providing said user with access to said a service; and
means for generating, in response to said user specific record, an access message for providing said user with access to said service.

28. Mobile user equipment as claimed in claim 27 wherein said means for using a user specific record comprises means for storing a user specific record.
